(19) United States
(12) Patent Application Publication
(10) Pub. No.: US 2012/0233102 A1
(43) Pub. Date: Sep. 13, 2012

(54) APPARATUS AND ALGORITHMIC PROCESS FOR AN ADAPTIVE NAVIGATION POLICY IN PARTIALLY OBSERVABLE ENVIRONMENTS

(75) Inventor: Michael Robert JAMES, Northville, MI (US)

(73) Assignee: Toyota Motor Engin. & Manufact. N.A.(TEMA), Erlanger, KY (US)

(21) Appl. No.: 13/046,474

(22) Filed: Mar. 11, 2011

(51) Int. Cl. G06F 15/18

(52) U.S. Cl. 706/14

(57) ABSTRACT

An apparatus and method for automatic learning of high-level navigation in partially observable environments with landmarks uses full state information available at the landmark positions to determine navigation policy. Landmark Markov Decision Processes (MDPs) can be generated only for encountered parts of an environment when navigating from a starting state to a goal state within the environment, thereby reducing computational resources needed for a navigation solution that uses a fully modeled environment. An MDP policy is calculated using the SarsaLandmark algorithm, and the policy is transformed to a navigation solution based on the current position and connectivity information.

### BACKGROUND

1. Field of the Disclosure

This disclosure is related to apparatuses, processes, algorithms and associated methodologies directed to adaptive learning of high-level navigation in a partially observable environment with landmarks.

2. Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against this disclosure.

Reinforcement learning is an area of machine learning associated with developing a policy to map a current state in an environment, which is formulated as a Markov Decision Process (MDP), to an action to be taken from that state in order to maximize a reward. The state can represent a physical location, a state in a control system, or a combination of physical location with other discrete attributes (e.g. traffic conditions, time of day) that may affect the decision making process.

State-Action-Reward-State-Action (SARSA) is an algorithm for learning an MDP policy. A SARSA agent interacts with the environment and updates the policy based on actions taken by the agent.

### SUMMARY

When the environment is not fully observable, such that the state at any given position may not be fully sensed and known, additional challenges are introduced to reinforcement learning. Planning with partially observable MDPs (POMDPs) or learning a policy for taking actions in a partially observable environment is generally associated with having a complete model of the environment in advance, which may be estimated by the agent through interaction with the real-world environment over multiple occasions. Thus, although the full state at a given point may not be fully sensed or known, the overall environment is known.

Reinforcement learning algorithms that use eligibility traces, such as Sarsa(λ), can be effective in learning estimated-state-based policies in POMPDs but can also fail to find a good policy even when one exists.

This disclosure is directed to an autonomous or semi-autonomous vehicle, such as a robot or intelligent ground vehicle, for example, which automatically/adaptively learns high-level navigation policies in a partially observable environment, where sensing capabilities are unable to fully discern the position or state in many situations. For instance, an intelligent ground vehicle may have a graph-based map of roadways, but the traffic conditions along each road may be imperfectly known. Thus, the state is only partially observable.

In a partially observable environment that is not modeled in advance, the use of landmarks enhances automatic learning of navigation policies. Further, by using the landmarks located between a starting state and a goal state, a long and computationally inefficient navigation problem is discretized into a series of small and computationally efficient navigation problems.

As a result, necessary computing hardware resources are reduced because it is not necessary to compute all possible paths from a start point to a goal point. Rather, the use of landmarks creates relatively shortened paths constituting parts of a possible path from a start point to a goal point. Further, all of the possible paths from a start point to a goal point can include a number of landmarks, and optimizations of path portions can be made between each of the land marks to determine optimized travel paths without taking into consideration the actual start point and the actual goal point when optimizing those path portions.

This disclosure is directed to methods, apparatus, devices, algorithms and computer-readable storage medium including processor instructions for navigating from a starting state to a goal state in a partially-observable environment. The overall navigating includes identifying locations within the environment, such that connections between the locations form a plurality of different paths between the starting state and the goal state, and determining a reward value for each connection from one location to another location. Landmarks are identified from among the locations, and a value function is associated for each connection from one landmark to another location or landmark. The value function summarizes reward values from the one landmark to the goal start. Navigating is performed from the starting state to the goal state by applying a policy to information gathered by at least one sensor to select connections at each location to form a path to the goal state.

In one embodiment, the navigating includes selecting a connection based on value functions and reward values indicated for each connection originating from an encountered landmark. Further, the selection of a connection is performed, preferably, only at encountered locations, during the navigating, to form the path.

In a preferred aspect, a process of updating a value function associated with a connection from a landmark based on changes in reward values from the landmark to the goal state via the connection is performed, where the selection of a connection is based on the updated value function.

In another embodiment, the policy includes maximizing reward values of a path of the selected connections to the goal state, where the reward values are preferably negative values which have a magnitude reflecting costs associated with each connection.

These costs may include traffic information, specifically traffic congestion information and road speed information. Here, the cost for a connection increases proportional to traffic congestion and inversely proportional to road speed.

In one aspect, the information gathered by the at least one sensor includes the traffic congestion information and the road speed information so that the selection of connections at each location to form the part to the goal state reflects the traffic congestion and the road speed. In a further aspect, the at least one sensor gathers the traffic congestion information and the road speed information in real-time so that the traffic congestion information and the road speed information reflects the traffic congestion and the road speed in real-time.

In yet another embodiment, a user selects a particular location or landmark for the path to include such that the selection of connections at each location to form the path to the goal state includes a connection to the particular location or landmark.

In aspects embodied on a computer-readable storage medium storing a set of instruction which, when executed by a processor, cause the processor to perform a method in accordance with the above aspects, the computer-readable storage medium is preferably a functional hardware component of an electronic control unit for a vehicle. In further aspects, a navigation control unit in accordance with the above aspects is installed into a vehicle and instructs actuators of the vehicle that control steering, throttling and braking of the vehicle.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an algorithmic block diagram of a navigation system;

FIG. 2 shows an algorithm by way of a flowchart illustrating the steps performed by the Navigation to Landmark MDP Transformation Module of the navigation system;

FIG. 3 shows an exemplary navigation environment;

FIG. 4 shows an algorithm by way of a flowchart illustrating a method of navigating; and

FIG. 5 shows a computing/processing system for implementing algorithms and processes of navigating according to this disclosure.

### DETAILED DESCRIPTION OF THE PREFERRED EMBODIMENTS

Referring now to the drawings, wherein like reference numerals designate identical or corresponding parts throughout the several views, descriptions of non-limiting embodiments of the invention are provided.

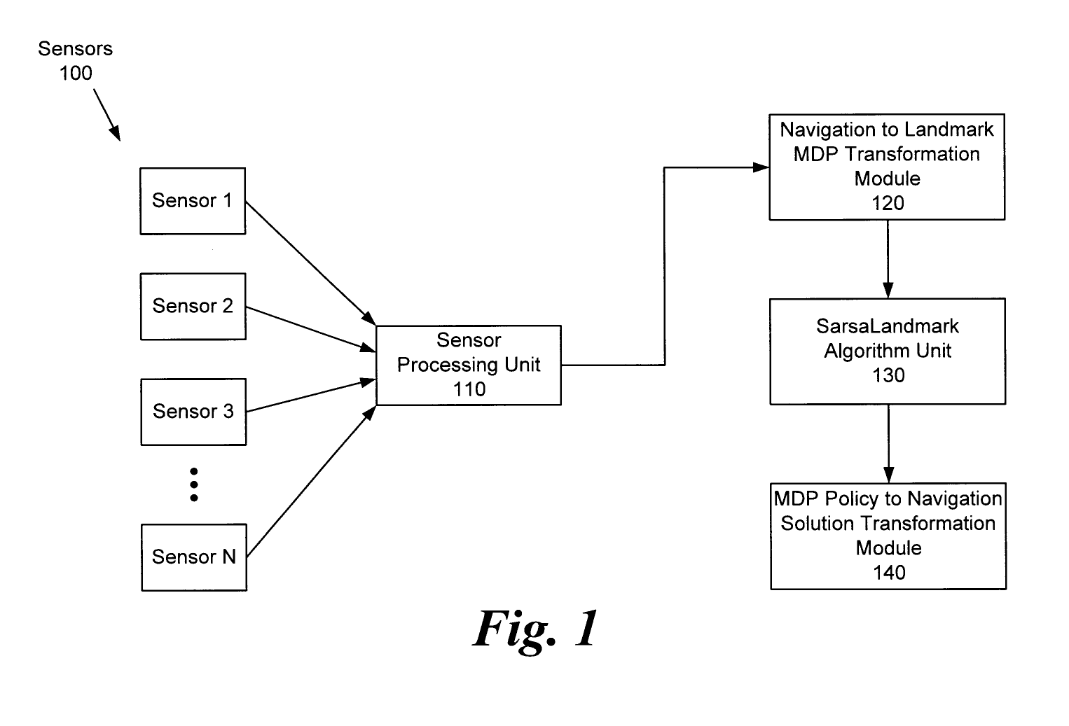

FIG. 1 illustrates an algorithmic block diagram of a navigation system according to an embodiment of this disclosure. The sensors 100 sense the encountered environment and input data to the sensor processing unit 110. These sensors include (but are not limited to) units such as GPS sensors with a corresponding map database, wheel speed sensors, and real-time traffic report sensors. The sensor processing unit 110 uses the input sensor data to output location or state information, connectivity, and cost information to the Navigation to Landmark MDP Transformation Module 120. The Navigation to Landmark MDP Transformation Module 120 uses the input location or state information, connectivity, and cost information to transform the navigation problem into a landmark MDP.

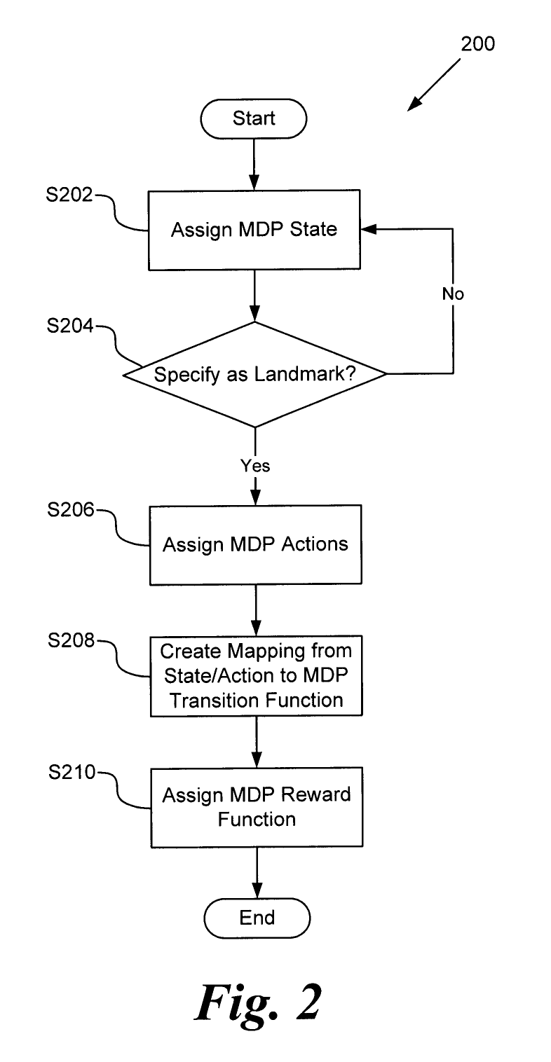

FIG. 2 shows an algorithm by way of a flowchart 200 illustrating steps performed by the Navigation to Landmark MDP Transformation Module 120 to transform the navigation problem into a landmark MDP. At step S202, an MDP state is assigned to the location or state input from the sensor processing unit 110. At S202, a determination is made as to whether the MDP state is a landmark.

A landmark generally refers to a physical structure or environmental characteristic. Preferably, the landmark refers to a location of a prominent or well-known object, feature or structure. In many aspects, the landmark is a unique characteristic of the environment, and is thus easily identifiable through sensors and indicating a particular location without erroneously detecting the location as a different location not associated with the unique characteristic. As such, in some aspects, the landmark includes several prominent or well-known objects, features and/or structures arranged in a particular way that distinguishes the landmark as a unique location.

If an MDP state is specified as a landmark, then full state information is available at the position, and at S206, MDP actions are assigned that are equal to the maximal connectivity from the state. Otherwise, if no at S204, then the algorithm 200 returns to S202 to assign a new MDP state.

After assigning the MDP actions, a mapping is created from a state/action pair to an MDP transition function at S208. The function may be probabilistic if such a mapping is suitable (for instance, when transitions have a possibility of failure due to blockage). At step S210, an MDP reward function is assigned to the MDP state based on the navigation cost. An MDP reward may, in fact, be a cost (i.e. negative reward). A positive reward is assigned for reaching an identified goal.

The Navigation to Landmark MDP Transformation Module 120, in one aspect, is executed online such that parts of the environment are transformed to Landmark MDPs as they are encountered. That is, “online” refers to the adaptability of this algorithm to transform just a portion of a problem that has been encountered so far, and integrating new location/connectivity/cost information as it is encountered. This adaptability leads to a more flexible approach when applied to a real-world navigation system.

The SarsaLandmark Algorithm Unit 130, shown in FIG. 1, uses the landmark MDP generated by the Navigation to Landmark MDP transformation module 120 with currently sampled environment and current goal information to find a best navigation policy or MDP policy at any given time.

The SarsaLandmark Algorithm executed by the SarsaLandmark Algorithm Unit 130 is detailed in “SarsaLandmark: An Algorithm for Learning in POMDPs with Landmarks,” Michael R. James, Satinder Singh, Proc. Of 8^{th} Int. Conf. on Autonomous Agents and Multiagent Systems (AAMAS 2009), Decker, Sichman, Sierra and Castelfranchi (eds.), May, 20-15, 2009, Budapest, Hungary, pp. 585-592. This document is incorporated herein in its entirety by reference. This document provides a theoretical analysis of the SarsaLandmark algorithm for the policy evaluation problem and presents empirical results for a few learning control problems. The MDP Policy to Navigation Solution Transformation Module 140 of FIG. 1 uses a computed MDP policy and connectivity mapping to determine a best high-level navigation solution.

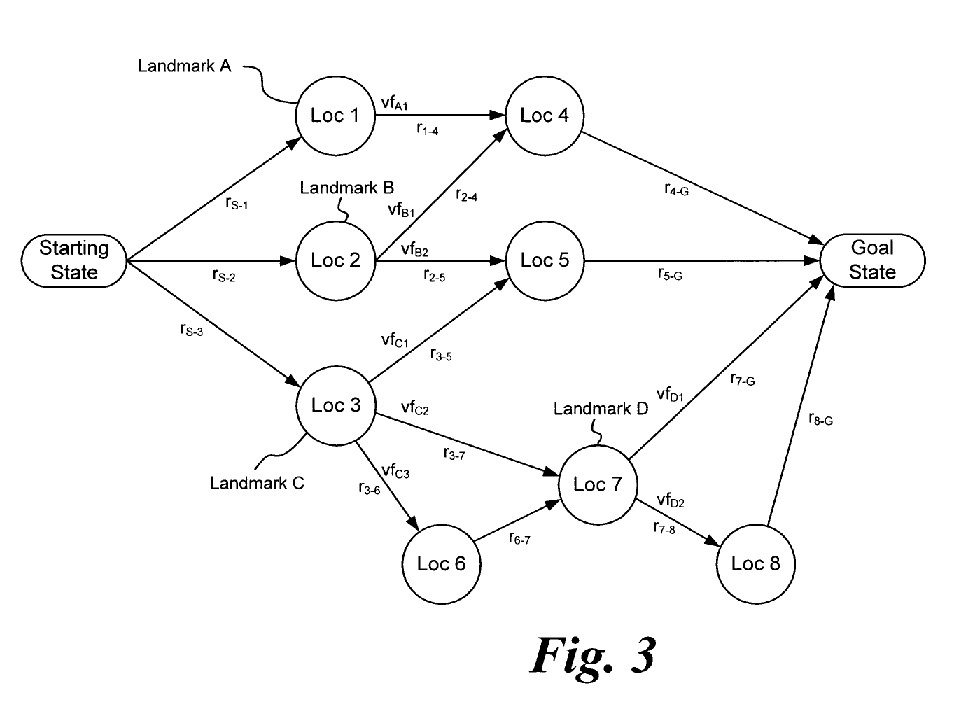

FIG. 3 shows an exemplary navigation environment. As shown, each location Loc 1 to Loc 8, has one or more connections originating from it. Each connection has an associated reward value. For example, r₁₋₄ is the reward for the connection from Loc 1 to Loc 4.

Some of the locations are also landmarks. For example, those locations which are specified as landmarks at S204 of FIG. 2 are identified as landmarks in FIG. 3. Here, Loc 1, Loc 2, Loc 3 and Loc 7 are specified as Landmarks A-D, respectively. The landmarks have value functions associated with each connection originating from the landmark, in addition to the reward value. A value function at a given landmark, associated with a given connection, summarizes the reward values from the given landmark to the goal state via the given connection. For example, vf_{c2} summarizes the reward values from Loc 3 to the goal state via Loc 7.

In summarizing reward values for a value function, several varying procedures can be followed. Value function vf_{B2} from Landmark B (Loc 2) to Loc 5 can merely reflect a summation of r₂₋₅ and r_{5-G} because these rewards correspond to the only possible connections between Landmark B and the Goal State when taking the connection associated with vf_{B2}. That is, only one possible path exists in that scenario. However, this procedure is complicated when there is more than one possible path, and thus more than one combination of connections available for navigation.

Adverting back to vf_{c2}, which summarizes the reward values from Loc 3 to the goal state via Loc 7, it can now be appreciated that the summarized reward value can be calculated by different methods. The reward r₃₋₇ will be included in any calculation of vf_{c2}, but the calculation of vf_{c2} does not necessarily include all of r_{7-G}, r₇₋₈ and r_{8-G} (that is, vf_{D1} and vf_{D2} because Loc 7 is also Landmark D). As is typical in a reinforcement algorithm, whichever of vf_{D1} and vf_{D2} indicates the highest reward (or lowest cost) is used in the calculation.

In one aspect, instead of relying upon an initial calculation which is then updated to reflect encountered locations, an initial (non-updated yet) value function can be stored a priori in a landmark database which associates various known landmarks with known value functions. This known value function will likely only provide an estimate value function for the particular Goal State. However, this estimate can be revised with known or predicted information (such as traffic conditions or road speed limits) and updated with encountered information as appropriate.

It should be appreciated FIG. 3 is shown in a forward-only direction, where a navigating vehicle does not reverse directions. However, this is only one aspect. According to other aspects of this disclosure, reward and function values can be assigned to reverse connections to account for unforeseen stoppages or blocks in a path (e.g., road construction, bridge closing, etc.). In some aspects, the reward and function values for a reverse connection are only calculated or determined as necessarily encountered. However, in other aspects, these reverse connection values can also be calculated a priori and updated as encountered.

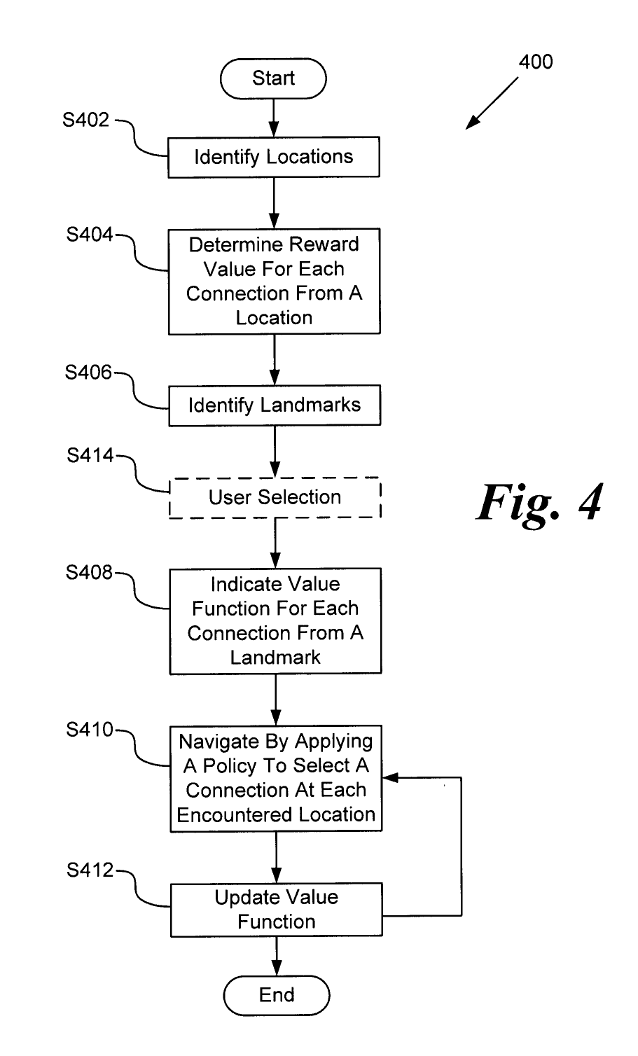

FIG. 4 shows an algorithm by way of a flowchart 400 illustrating a method of navigating according to an embodiment of this disclosure. Step S402 includes identifying locations, which may be only the as-yet encountered locations or states within the environment. Then, at step S404, a reward value is determined for each connection originating from an identified location. Landmarks or fully-sensed states are identified among the identified locations at step S406, and a value function is indicated for each connection from a landmark at S408.

Step S410 includes navigating (e.g., by an automated vehicle) by applying a policy and selecting a connection originating from an encountered location. Connections are preferably selected to reach a maximum reward or minimize a cost associated with the combination of selected connections (the path).

However, deviations are allowed, as are selections by a user that a particular location or landmark be traversed as an intermediate goal state in progressing to the final goal state. For example, a user can specify a particular connection that needs to be used or a particular location/landmark that needs to be used, which creates a rule that the maximization/minimization procedure adheres to.

In other aspects, determinations as to which connection to take can be made based on sensor-input information at the time the vehicle encounters each location. Thus, a final path is not predetermined. Rather, decisions are made in real-time to accommodate new sensor readings and updated value functions, which is discussed below.

At step S412, a value function is updated to reflect a change to any of the reward values summarized by the value function. For example, if increased traffic congestion reduces the reward (i.e. increases the cost) of a connection between a given landmark and the goal state, the value function is updated to reflect that change. As a result, the updated value function is preferably followed by the selection of a connection to a next location.

In a further aspect, after the locations have been identified and after the landmarks have been identified (steps S402 and S406, respectively), a user can select a particular location or landmark identified at S414. Although shown in FIG. 4 as immediately following S406, this is not necessary. For example, a user can select a particular location or landmark according to S414 at any time prior to or during navigation to cause the navigating to include the particular location or landmark as a point to include the navigation path.

Those skilled in the relevant art will understand that the above-described functions can be implemented as a set of instructions stored in one or more computer-readable media, for example. Such computer-readable media generally include memory storage devices, such as flash memory and rotating disk-based storage mediums, such as optical disks and hard disk drives.

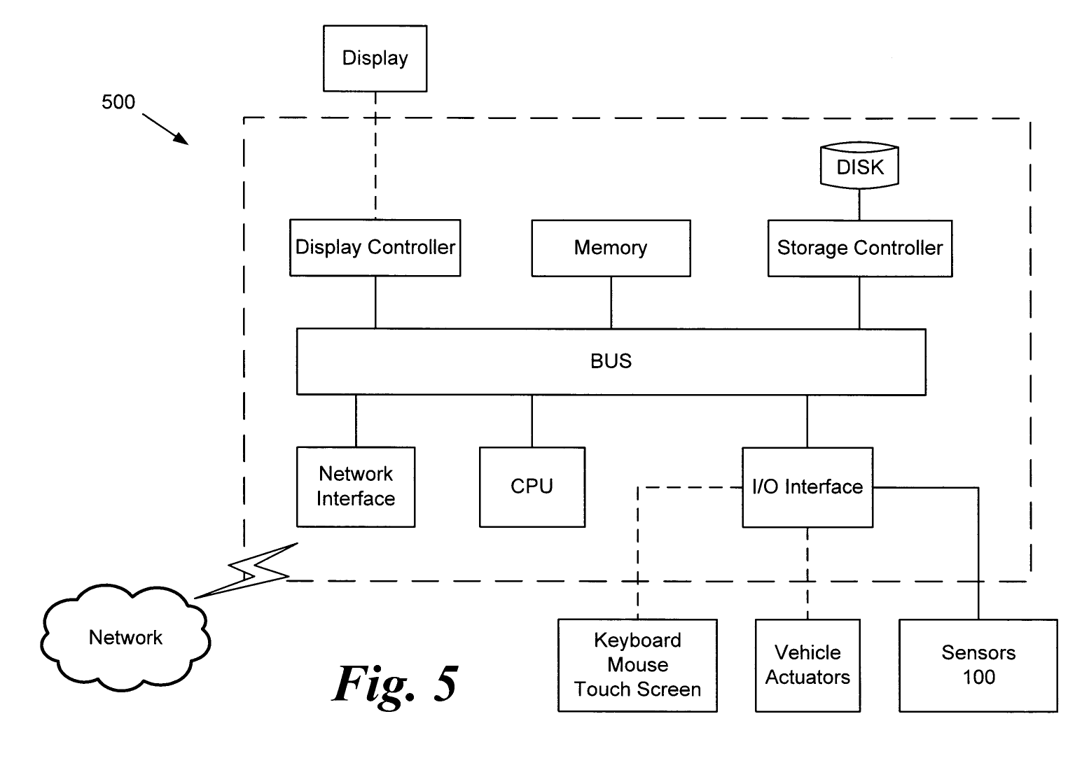

FIG. 5 shows a computing/processing apparatus 500 for implementing a method of navigating according to an embodiment of this disclosure. Generally, the apparatus 500 includes computer hardware components that are either individually programmed or execute program code stored on various recording medium, including memory, hard disk drives or optical disk drives. As such, these systems can include application specific integrated controllers and other additional hardware components.

In an exemplary aspect, the apparatus 500 is an electronic control unit (ECU) of a motor vehicle and embodies a computer or computing platform that includes a central processing unit (CPU) connected to other hardware components via a central BUS. The apparatus includes memory and a storage controller for storing data to a high-capacity storage device, such as a hard disk drive or similar device. The apparatus 500, in some aspects, also includes a network interface and is connected to a display through a display controller. The apparatus 500 communicates with other systems via a network, through the network interface, to exchange information with other ECUs or apparatuses external of the motor vehicle.

In some aspects, the apparatus 500 includes an input/output interface for allowing user-interface devices to enter data. Such devices include a keyboard, mouse, touch screen, and/or other input peripherals. Through these devices, the user-interface allows for a user to manipulate locations or landmarks, including identifying new locations or landmarks. The input/output interface also preferably inputs data from sensors, such as the sensors 100 discussed above, and transmits signals to vehicle actuators for steering, throttle and brake controls for performing automated functions of the vehicle.

In another aspect, instead of transmitting signals directly to vehicle actuators, the apparatus 500 transmits instructions to other electronic control units of the vehicle which are provided for controlling steering, throttle and brake systems. Likewise, instead of directly receiving systems information from the sensors 100 via the input/output interface, in an alternative aspect the apparatus 500 receives sensor information from various sensor-specific electronic control units.

It should be appreciated by those skilled in the art that various operating systems and platforms can be used to operate the apparatus 500 without deviating from the scope of the claimed invention. Further, the apparatus 500 can include one or more processors, executing programs stored in one or more storage media to perform the processes and algorithms discussed above.

Exemplary processors/microprocessor and storage medium(s) are listed herein and should be understood by one of ordinary skill in the pertinent art as non-limiting. Microprocessors used to perform the algorithms discussed herein utilize a computer readable storage medium, such as a memory (e.g. ROM, EPROM, EEPROM, flash memory, static memory, DRAM, SDRAM, and their equivalents), but, in an alternate embodiment, could further include or exclusively include a logic device. Such a logic device includes, but is not limited to, an application-specific integrated circuit (ASIC), a field programmable gate array (FPGA), a generic-array of logic (GAL), a Central Processing Unit (CPU), and their equivalents. The microprocessors can be separate devices or a single processing mechanism.

Obviously, numerous modifications and variations of the present disclosure are possible in light of the above teachings. It is therefore to be understood that within the scope of the appended claims, the invention may be practiced otherwise than as specifically described herein.

1. A method for navigating from a starting state to a goal state in a partially-observable environment, the method comprising:
identifying locations within the environment, such that connections between the locations form a plurality of different paths between the starting state and the goal state;
determining a reward value for each connection from one location to another location;
identifying landmarks among the locations;
associating a value function for each connection from one landmark to another location or landmark, the value function summarizing reward values from the one landmark to the goal state; and
navigating from the starting state to the goal state by applying a policy to information gathered by at least one sensor to select connections at each location to form a path to the goal state.

2. The method according to claim 1, wherein the navigating includes selecting a connection based on value functions and reward values indicated for each connection originating from an encountered landmark.

3. The method according to claim 2, wherein the selection of a connection is performed only at encountered locations, during the navigating, to form the path.

4. The method according to claim 3, further comprising:
updating a value function associated with a connection from a landmark based on changes in reward values from the landmark to the goal state via the connection, wherein the selection of a connection is based on the updated value function.

5. The method according to claim 1, wherein the policy includes maximizing reward values of a path of the selected connections to the goal state.

6. The method according to claim 5, wherein the reward values are negative values which have a magnitude reflecting costs associated with each connection.

7. The method according to claim 6, wherein the costs include traffic information.

8. The method according to claim 7, wherein
the traffic information includes traffic congestion information and road speed information, and
the cost for a connection increases proportional to traffic congestion and inversely proportional to road speed.

9. The method according to claim 8, wherein the information gathered by the at least one sensor includes the traffic congestion information and the road speed information so that the selection of connections at each location to form the part to the goal state reflects the traffic congestion and the road speed.

10. The method according to claim 9, wherein the at least one sensor gathers the traffic congestion information and the road speed information in real-time so that the traffic congestion information and the road speed information reflects the traffic congestion and the road speed in real-time.

11. The method according to claim 1, further comprising:
selecting, by a user, a particular location or landmark for the path to include such that the selection of connections at each location to form the path to the goal state includes a connection to the particular location or landmark.

12. A computer-readable storage medium storing a set of instructions which, when executed by a processor, cause the processor to perform a method according to claim 1 for navigating from a starting state to a goal state in a partially-observable environment.

13. The computer-readable storage medium according to claim 12, wherein the computer-readable storage medium is a functional hardware component of an electronic control unit for a vehicle.

14. A navigation apparatus for navigating from a starting state to a goal state, the apparatus comprising:
means for identifying locations within the environment, such that connections between the locations form a plurality of different paths between the starting state and the goal state;
means for determining a reward value for each connection from one location to another location;
means for identifying landmarks among the locations;
means for associating a value function for each connection from one landmark to another location or landmark, the value function summarizing reward values from the one landmark to the goal state; and
means for navigating from the starting state to the goal state by applying a policy to information gathered by at least one sensor to select connections at each location to form a path to the goal state.

15. A navigation control unit for navigating from a starting state to a goal state having hardware computing components including a processor and memory, the control unit comprising:
a location unit configured to identify locations within the environment, such that connections between the locations form a plurality of different paths between the starting state and the goal state;
a reward unit configured to determine a reward value for each connection from one location to another location;
a landmark unit configured to identify landmarks among the locations;
a value function unit configured to associate a value function for each connection from one landmark to another location or landmark, the value function summarizing reward values from the one landmark to the goal state; and
a navigating unit configured to navigate from the starting state to the goal state by applying a policy to information gathered by at least one sensor to select connections at each location to form a path to the goal state.

16. The navigation control unit according to claim 15, wherein the navigation control unit is installed into a vehicle and the navigating unit is configured to instruct actuators of the vehicle that control steering, throttling and braking of the vehicle.
